(19) United States
(12) Patent Application Publication
(10) Pub. No.: US 2008/0260346 A1
(43) Pub. Date: Oct. 23, 2008

(54) VIDEO RECORDING APPARATUS

(76) Inventors: Hiroko SUKEDA, Tokorozawa (JP); Youichi Horii, Mitaka (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/873,089

(22) Filed: Oct. 16, 2007

(30) Foreign Application Priority Data
Oct. 17, 2006 (JP) 2006-282144

(51) Int. Cl. H04N 5/91

(52) U.S. Cl. 386/46; 386/E05.001

(57) ABSTRACT

A video recording apparatus includes a receiver for receiving video information from an external device, a recorder for recording video information received by the receiver, and a controller for separating a thumbnail image from the video information. The video information includes first additional information including frame time information and priority information of the video information. The controller separates the thumbnail image from the video information on the basis of the first additional information.

### CLAIM OF PRIORITY

The present application claims priority from Japanese application JP2006-282144 filed on Oct. 17, 2006, the content of which is hereby incorporated by reference into this application.

### BACKGROUND OF THE INVENTION

The present invention relates to a video recording apparatus for storing and managing a video program, and in particular, to a method of setting a program thumbnail image of a program to facilitate distinction of the program and a video recording apparatus in which the method is installed.

There have been broadly employed program recording apparatuses to record television programs in a hard disk, a Digital Versatile Disk (DVD), or a video tape for the user to later view the programs thus recorded in advance. For the user to easily distinguish the programs, it is a common practice to display thumbnail images representing parts of the programs. Based on the thumbnail images, the user recognizes the programs to conduct an operation, for example, to reproduce a desired program.

In general, such a thumbnail image is obtained from video signals beforehand recorded, by separating or cutting an image out of a predetermined frame. Specifically, there is obtained in many cases, as the thumbnail image, a frame image from the video signals at a position corresponding to a lapse of a predetermined period of time (e.g., one minute) relative to the recording start point (reference is to be made to, for example, JP-A-2003-61039). According to another technique, it is possible that the viewer sets, when a program is recorded or reproduced, the lapse of time to separate the frame (reference is to be made to, for example, JP-A-2003-32581 and JP-A-2005-151085).

On the other hand, to efficiently view a program by primarily changing the video reproducing speed for each scene of the program, there has been proposed a method of externally obtaining a reproducing script regarding the program from a device outside the recording apparatus(reference is to be made to JP-A-2005-236527). According to this method, it is possible to externally define a program viewing method via a network or the like by using as a key a predetermined period of time relative to the program start time. In addition, JP-A-2005-354642 describes a program information processing system including a program information managing server to store program meta-information, i.e., meta-information regarding programs and a program information terminal to present on its display a list of programs created on the basis of the program meta-information. Additionally, there has been provided a service in which a program is subdivided into scenes to distribute, via a network, program metadata in which description is added to each scene. According to this service, it is possible to externally define, via a network or the like, additional information for each scene of the program using, as a key, a predetermined period of time relative to the program start time.

### SUMMARY OF THE INVENTION

The convention method of setting a program thumbnail image is attended with a problem that the image obtained by separating a frame corresponding to a point of time when a predetermined period of time lapses relative to the program start point does not necessarily appropriately reflect the contents of the program. Particularly, in a program which is weekly broadcast at the same time, the images separated as above are the same title images every week. Therefore, the recorded programs cannot be distingished from each other in some cases. There may disadvantageously occur a situation in which the obtained image is part of a commercial image by chance.

There has been proposed a method for the user to arbitrarily set, for each program, a point of time to separate a frame. In this method, the user manually sets a frame of a thumbnail image at reservation or reproduction of the program. However, it is disadvantageously required for the user to carry out troublesome and complex operations.

The service of “Television Blog” described above provides a mechanism including a function to distribute, via a network, metadata regarding the program for the browsing thereof and a function in which the user transmits comments and the like on a program or a scene. However, reference has been made to neither a method nor a device to automatically extract a representative video image corresponding to a desired point of time, by combining these functional elements of the mechanism.

It is therefore an object of the present invention to provide a method and a program recording apparatus mounted with the method wherein a program thumbnail image of a program is set to facilitate distinction of the program through a simpler operation for the user (or without requiring user's operation), the thumbnail image appropriately reflecting the contents of the recorded video signals of the program.

To achieve the object, in the operation to select a thumbnail image, additional information (metadata) is employed to separate the thumbnail image, the additional information being obtainable from an external device by use of, for example, a network, a broadcast signal, and the like.

The metadata includes time information capable of identifying a thumbnail for each frame using “day and time” and a channel. In the program recording apparatus, a thumbnail image is separated as a representative image on the basis of a channel of video signals recorded as above and a recording time zone in which the video signals are recorded. If a plurality of metadata items exist as thumbnail candidates within the period of time of the recorded videos, a representative thumbnail image can be selected using information such as priority assigned thereto in advance. In this method, a representative scene of the videos can be set as a thumbnail image even if the recorded videos are not classified in program units (for example, when the recording period is designated in hours to record the videos or when the recorded videos include a plurality of programs). Also when scenes of a program are delimited for each chapter, it is possible to select a representative image for each chapter.

The metadata to select a thumbnail may be distributed from a broadcasting station or a performer or a sponsor. If the general viewers are allowed to generate and to distribute metadata, each viewer may select a most appropriate representative image matching the taste of the pertinent viewer from a large number of metadata items. Moreover, the viewer may finally select an appropriate image from candidates beforehand selected in the method described above.

Concretely, to achieve the object, the present invention has aspects as follows.

First, there is provided a video recording apparatus including a receiver for receiving video information from an external device, a recorder for recording video information received by the receiver, and a controller for separating a thumbnail image from the video information. The video information includes first additional information including frame time information and priority information of the video information. The controller separates the thumbnail image from the video information on the basis of the first additional information.

Second, according to the present invention, there is provided a video recording apparatus including a receiver for receiving video information from an external device, a recorder for recording video information received by the receiver, and a controller for separating a thumbnail image from the video information. The receiver obtains additional information regarding the video information via an internet. The additional information includes frame time information of the video information, information regarding posting points of time of posting from external communities, and information regarding the number of posting from external communities. The controller calculates priority on the basis of the additional information to thereby separate the thumbnail image from the video information.

According to the present invention, there can be provided a method and a video recording apparatus mounted with the method wherein a program thumbnail image of a program is set to facilitate distinction of the program through a simpler operation for the user, the thumbnail image possibly appropriately reflecting the contents of the recorded video signals of the program.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing a system configuration and a processing flow in a first embodiment.

FIG. 2 is a diagram showing a configuration of a video recorder.

FIG. 3 is a diagram to explain a conventional method.

FIG. 4 is a diagram to explain a proposed method.

FIG. 5 is a flowchart of a thumbnail separation procedure.

FIG. 6 is a diagram showing a metadata format to separate a thumbnail.

FIG. 7 is a diagram showing a flow of processing when different programs are contained in the recorded information.

FIG. 8 is a diagram showing a system configuration and a processing flow in a second embodiment.

FIG. 9 is a diagram showing similar image grouping (1).

FIG. 10 is a diagram to explain a processing flow of similar image grouping (2).

FIG. 11 is a diagram to explain automatic assignment of priority (1).

FIG. 12 is a diagram to explain a processing flow of automatic assignment of priority (2).

FIG. 13 is a diagram showing thumbnail selection is a recording section (1).

FIG. 14 is a flowchart showing operation of thumbnail selection is a recording section (2).

FIG. 15 is a diagram showing received metadata and a processing flow.

FIG. 16 is a diagram showing screen examples.

### DESCRIPTION OF THE EMBODIMENTS

### 1. First Embodiment

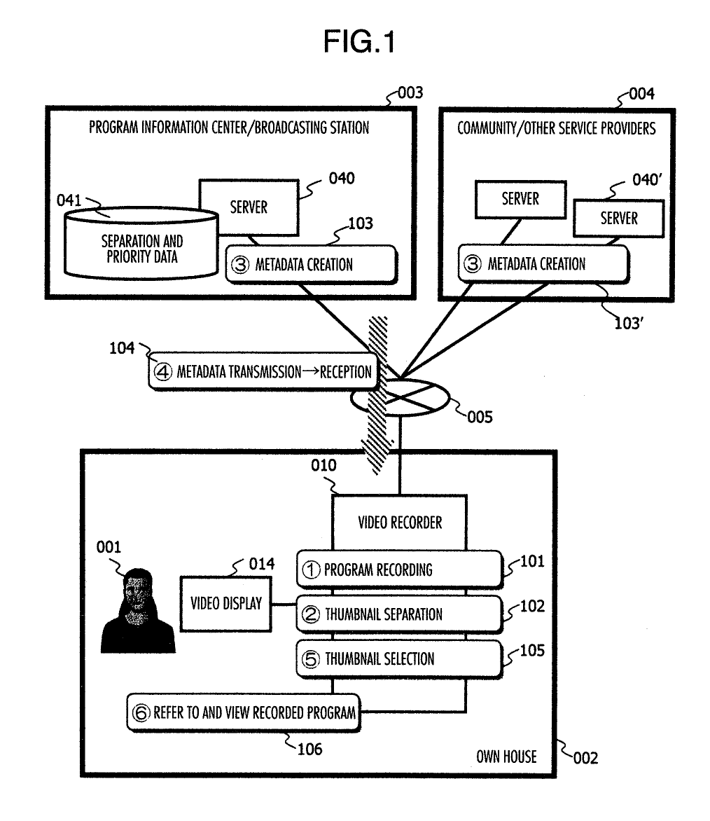

Referring now to FIGS. 1 to 7, description will be given of a first embodiment of a system implemented according to the present invention.

FIG. 1 shows a system configuration and a general processing flow of a first embodiment. A viewer 001 possesses a video recorder 010 in his or her own house or the like 002 and records and stores videos of programs therein. The video recorder 010 operates through operation phases as follows. In a first phase (101), according to a predetermined procedure, a program is recorded and the program recording is finished. In a second phase (102), a thumbnail image is separated as a representative image of the program using a predetermined method (e.g., by separating a frame corresponding to a point of time when one minute lapses after the recording is started). Concurrently, in a third phase (103), a program information center or a broadcasting station 003 or a community or a service provider 004 creates by a server 040 metadata to separate a thumbnail for the broadcast videos. In a fourth phase (104), the created metadata is transmitted on a network or with a broadcast signal to the video recorder 101. In a fifth phase (105), the video recorder 010 receives the metadata to select a thumbnail image according to a predetermined rule (if a thumbnail image has already been set, the video recorder 010 replaces the existing image with the selected image. In a sixth phase (106), the viewer 001 refers to or views a program recorded and stored in the video recorder 010 via a video display 014. If the thumbnail image separation of phase 2 is skipped, the representative image of the program is first determined through the thumbnail selection in phase 5.

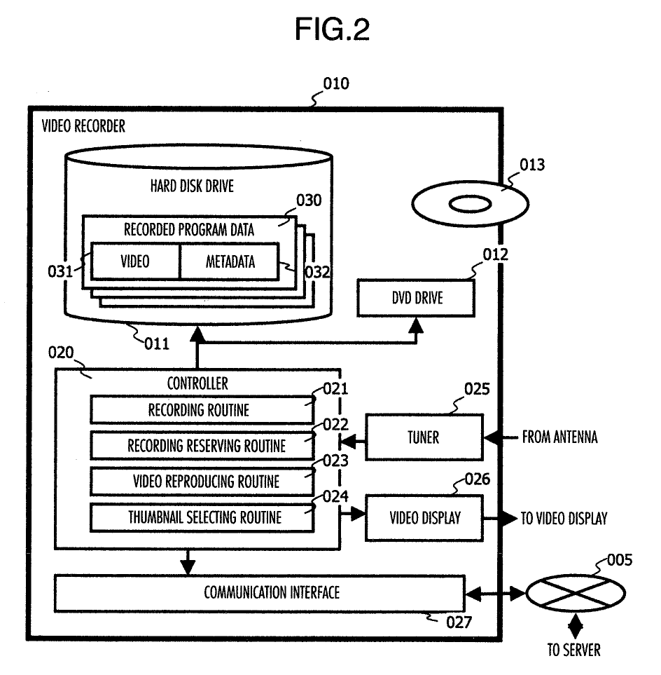

FIG. 2 shows a configuration of a video recorder employed in the system. The video recorder 010 includes recording media such as a hard disk drive 011, a DVD 013, and a DVD drive 012 to store information including videos, voice, control data to reserve recording of, for example, a program and to select a program to be viewed; a tuner 025 to receive via an antenna a video signal to input videos and the like to be stored in the recording media, a video display 026 to control a video display devices such as a television set and a monitor, and a communication unit 027 to connect via the internet 005 or the like to a server. If the video signals are received from other than the antenna, for example, from a cable or network communication line, there may be required a device such as a settop box in place of the tuner 025. The video display devices such as a television set and a monitor may be constructed in a unit to be integrally combined with the video recorder 010 or may be separated therefrom. The hard disk drive 011 stores data 030 of recorded programs. The data 303 includes video data 031 and metadata 032 which is information associated with the video data 031. The controller 020 includes processing modules to execute various processing such as a recording routine 021, a recording reserving routine 022, a video reproducing routine 023, a thumbnail selecting routine 024.

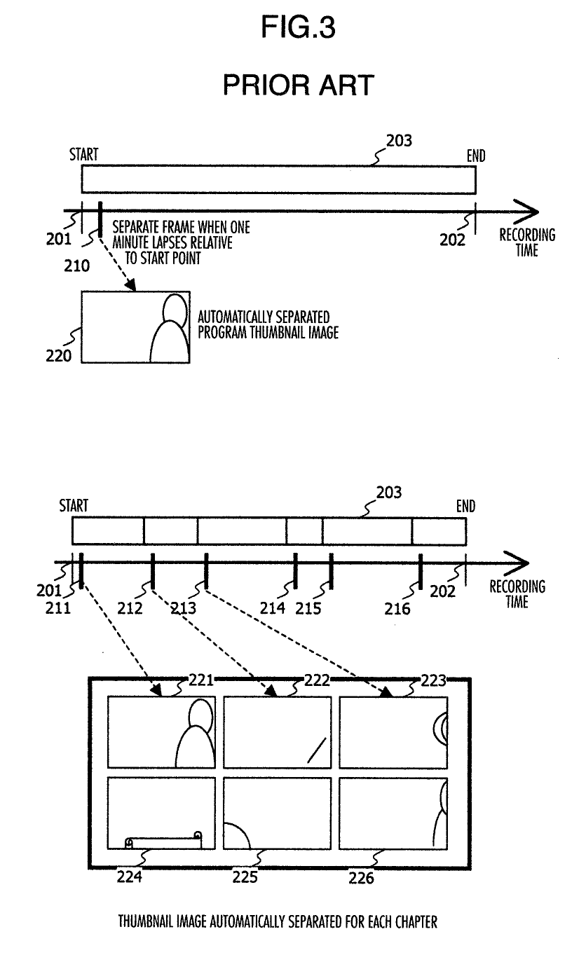

FIG. 3 shows an outline of processing to set a thumbnail image in a general conventional method. From a program 203 recorded in a time zone from a start time 201 to an end time 202, a frame 210 is separated at a predetermined time (when one minute lapses relative to the recording start point in this example) and is designated as a thumbnail image 220. Also for the videos subdivided for chapters, the images respectively of frames 211 to 216 separated when one minute lapses relative to the start points of the respective chapters) are designated as thumbnail images 221 to 226. In this method, it is not guaranteed that each of the thumbnail images automatically separated as above appropriately reflects the contents of the associated program or chapter. There hence may exist a situation wherein this method is not appropriately used to distinguish the program or chapter later depending on cases.

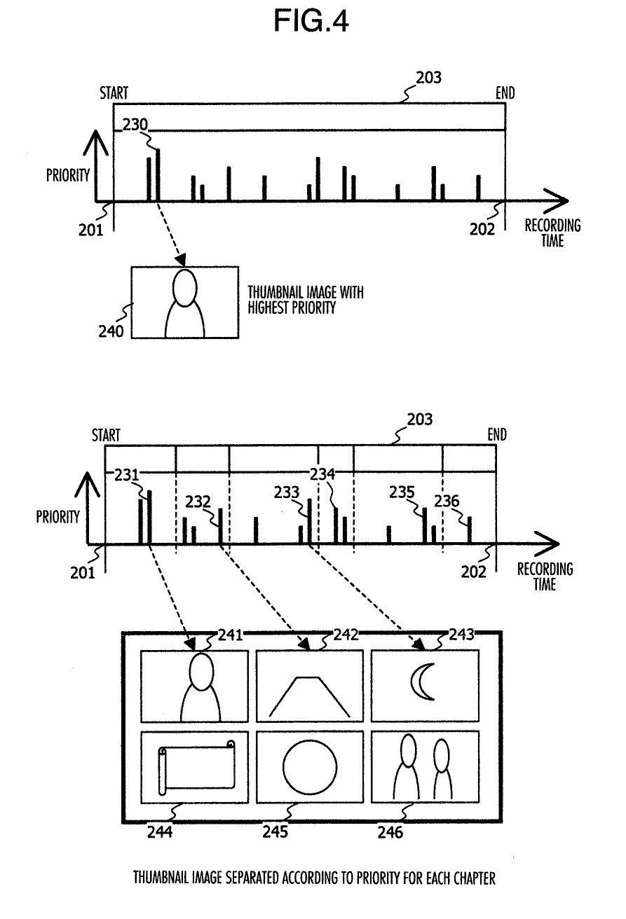

FIG. 4 shows an outline of the thumbnail image setting operation in a method proposed according to the present invention. It is assumed that for a program 203 recorded from a start time 201 to an end time 202, metadata representing priority of thumbnail selection for each predetermined point of time has been received by a predetermined module. An image obtained by separating a frame 230 with the highest priority within the program time zone is designated as a thumbnail image of the program. Using the metadata, chapters 231 to 236 having the highest priority in the respective ranges delimited by chapters are selected and separated to set thumbnail images 241 to 246 for the respective chapters. If the viewer does not desire to use a thumbnail image automatically selected as above, it is also possible that the user manually selects a thumbnail image from frames of metadata items as candidates and sets the thumbnail image in place of the automatically selected image.

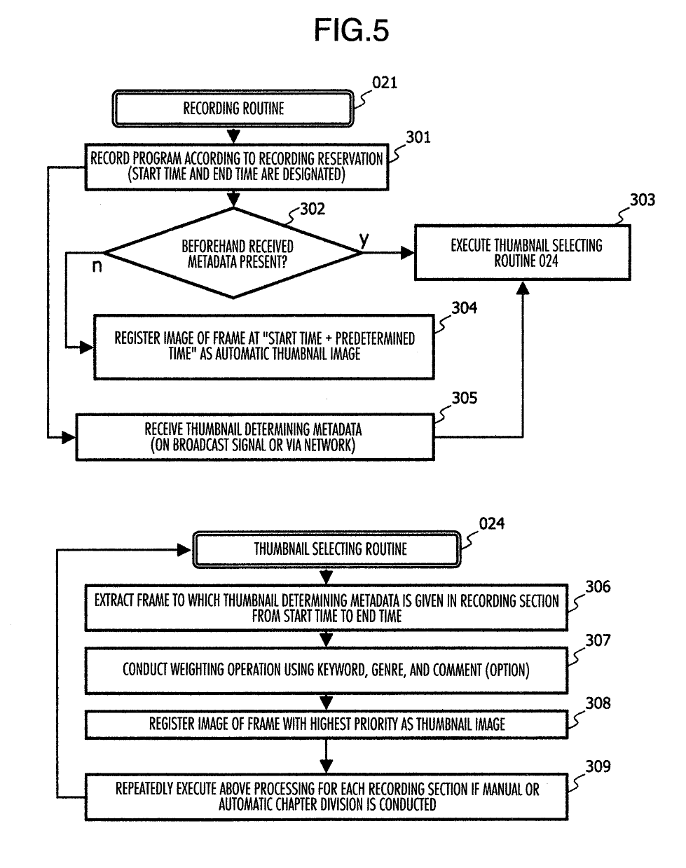

Referring now to FIG. 5, description will be given of a flow of processing primarily to select a thumbnail image in a recording apparatus according to the present invention. The recording routine 021 conducts a program recording step (301) based on the recording reservation as in the ordinary recording apparatus. If there exists metadata received in advance (302), processing of the thumbnail selecting routine 024 is executed, which will be described later. Otherwise, a frame is separated when a beforehand designated time lapses relative to the start time in a method similar to the conventional method to thereby set the default thumbnail image (304). When metadata to determine a thumbnail is received via a broadcast signal or a network at appropriate timing after the recording or during the broadcasting of the program (305), control goes to the thumbnail selecting routine 024.

The thumbnail selecting routine 024 extracts, in a time zone from the recording start time to the recording end time, a frame to which thumbnail selecting metadata is assigned (306). Thereafter, a weighting operation is conducted using conditions associated with items such as a keyword, a genre, or presence or absence of a comment, which will be described later, according to necessity (307), to thereby separate a frame image with the highest priority to set the image as a thumbnail image (308). If the chapter division is manually or automatically conducted after the thumbnail image is set, the above processing is repeatedly executed for each recording section or interval (309). If the viewer manually selects a thumbnail image, the selecting routine 024 again conducts the thumbnail image setting in which the image manually set by the viewer takes precedence.

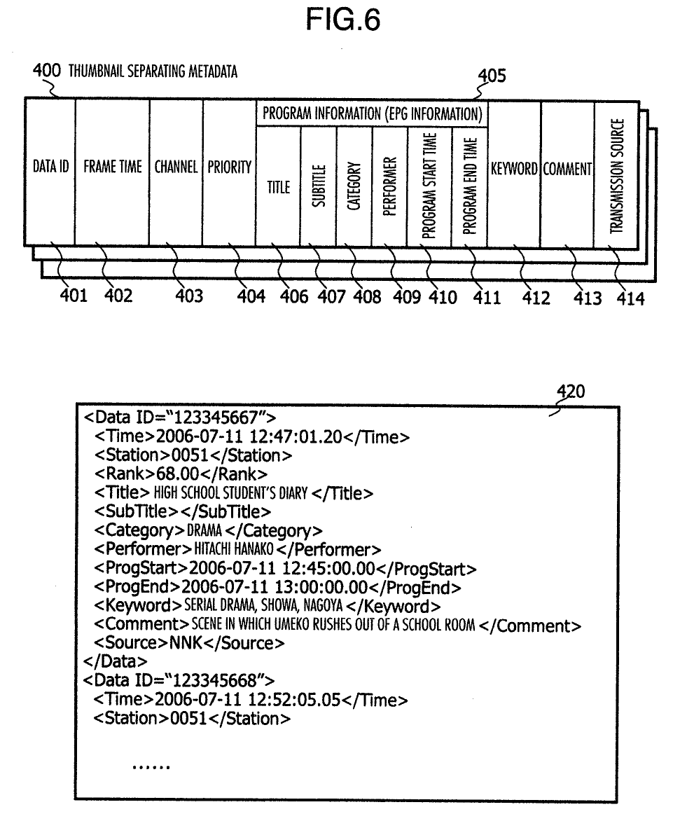

FIG. 6 shows a format of the thumbnail separating metadata. Each metadata item 400 includes a data IDentifier (ID) 401, a frame time 402, a channel 403, thumbnail separation priority 404, program information (primarily, Electronic Program Guide (EPG) information), i.e., information 405 such as a title 406, a subtitle 407, a category 408, a performer 409, a program start time 410, and a program end time 411; a keyword 412, a comment 413, and a transmission source 414. It is assumed that the metadata is distributed in, for example, an extensible Markup Language (XML) format indicated by a reference numeral 420, but the metadata is not necessarily restricted by the XML format.

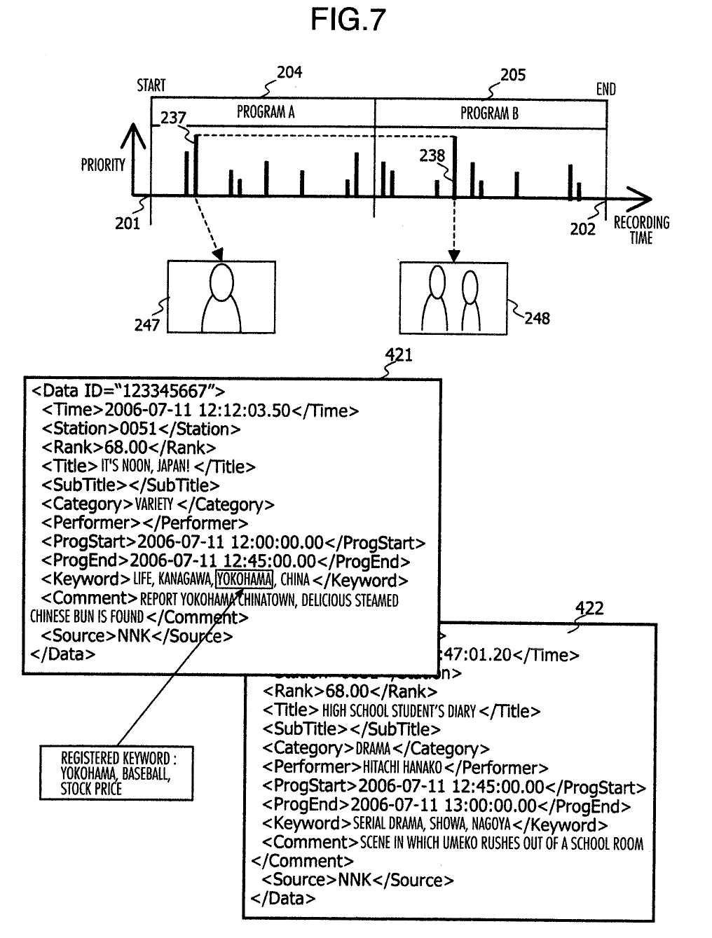

Description has been given of the present invention by mainly assuming that a single program is recorded through one recording operation. According to the method of the present invention, a thumbnail image may be set for each program. Additionally, it is also possible that the maximum priority in a desired recording section is employed as a reference in the thumbnail selection. Therefore, also when a plurality of programs are recorded and when part of a program is recorded through one recording operation, the method is effectively employed to select an optimal thumbnail image in a desired recording section. FIG. 7 shows processing to record a plurality of programs through one recording operation. If program A 204 and program B 205 are recorded from the start time 201 to the end time 202, a frame with the maximum priority is basically separated regardless of the pause or boundary between programs. Assume that the system is beforehand set to assign weights to the priority levels of the programs in the recording section which each include a keyword beforehand registered by the viewer. Even if there exists a plurality of frames with the same priority as frames 237 and 238, since the weights are assigned thereto as above, the system separates an image 247 of the frame 237 to set the image 247 as the thumbnail image. The weighting condition may include, in addition to the keyword described above, various items as reference items, e.g., a genre of the program as well as the creation time and the transmission source of the metadata. The weighting condition and parameters employed to set the priority may be beforehand set when the system is delivered.

Additionally, it is also possible to efficiently select an appropriate thumbnail image matching the taste of the viewer by disposing various functions as follows. For example, there are disposed a function for the viewer to change these items later and a function for the system to automatically learn these items. Also, the viewer may manually select a thumbnail image from frames with high priority selected according to the above reference.

### 2. Second Embodiment

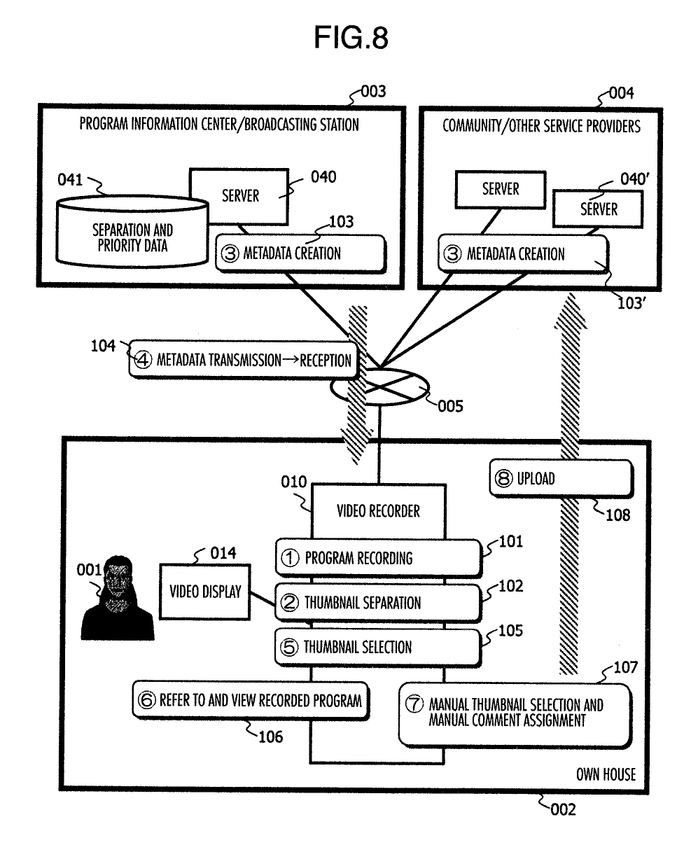

Referring next to FIG. 8, description will be given of a second example of a system according to the present invention. The second embodiment is almost equal in the basic configuration and processing procedures to the first embodiment shown in FIG. 1. However, the second embodiment additionally includes, in phase 6 in which the viewer 001 refers to and views recorded and stored programs via the video display 014, phase 7 (107) to manually select a thumbnail image and to assign a comment and phase 8 (108) to upload the created data into the server. This system is constructed by assuming a service or a community in which the viewer or another agent creates and uploads metadata and the metadata is shared to be distributed. The service provider 004 manages the metadata uploaded as above and distributes metadata items associated with a particular time zone and a particular channel to the respective recorders 010. As a result, it is possible to set the thumbnail image on the basis of various data items in addition to the metadata distributed from the particular broadcasting station or program information center 003.

### 3. Third Embodiment

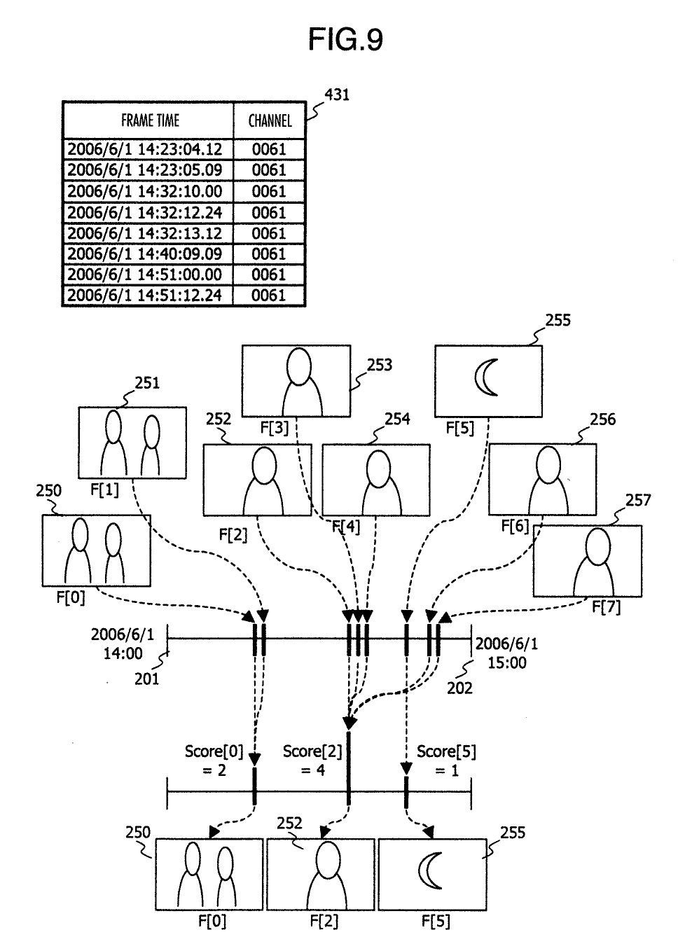

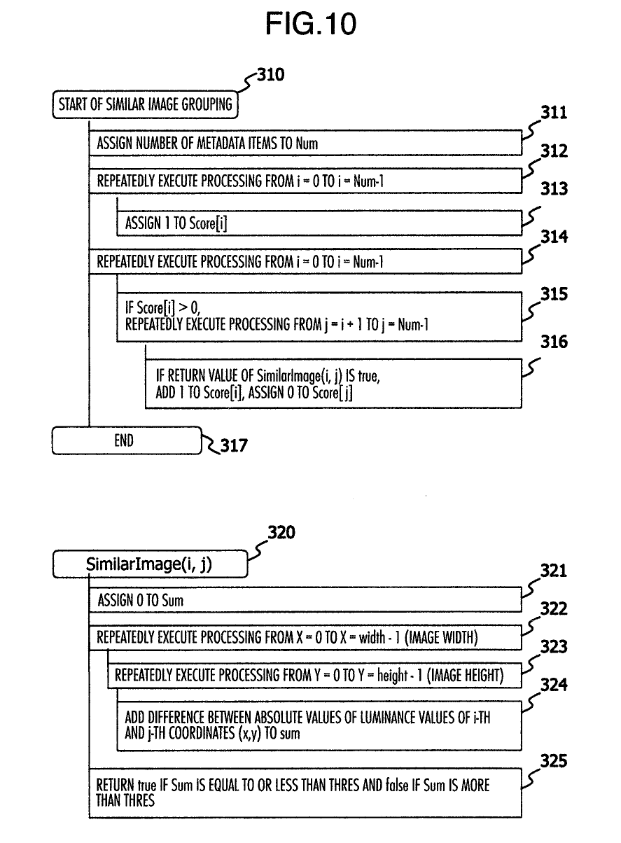

Referring now to FIGS. 9 and 10, description will be given of the weighting operation to select a frame with the maximum priority in a particular recording section. Referring to the flowchart shown in FIG. 10, description will be given of processing to select a program thumbnail image from the thumbnail image candidates F[0] 250 to F[7] 257 at reception of metadata 431 for videos in a time zone ranging from the start time 201 to the end time 202. First, the total number of metadata items is assigned to Num (311) and Score[i] is initialized for each value of i (312, 313). Next, according to the return value of function SimilarImage(i,j), processing (316) is repeatedly executed to update the values respectively of Score[i] and Score[j] in a range from j=i+1 to j=Num−1 (314, 315). Function SimilarImage 320 is a function to execute processing of steps 321 to 315 and determines similarity between two different images based on threshold value THRES designated in advance. As a result of the processing of FIG. 10, the eight thumbnail image candidates are classified into groups which each including similar images. The value of Score[i] of a representative image corresponds to the number of similar images. Therefore, as FIG. 9 shows, Score[2] corresponding to image F[2] having the largest number of similar images takes a value of four, i.e., the maximum value, and hence F[2] is set as the representative thumbnail image in the recording section. Through the processing, it is possible to select, from the given metadata items, a thumbnail image considered to most appropriately represent the program.

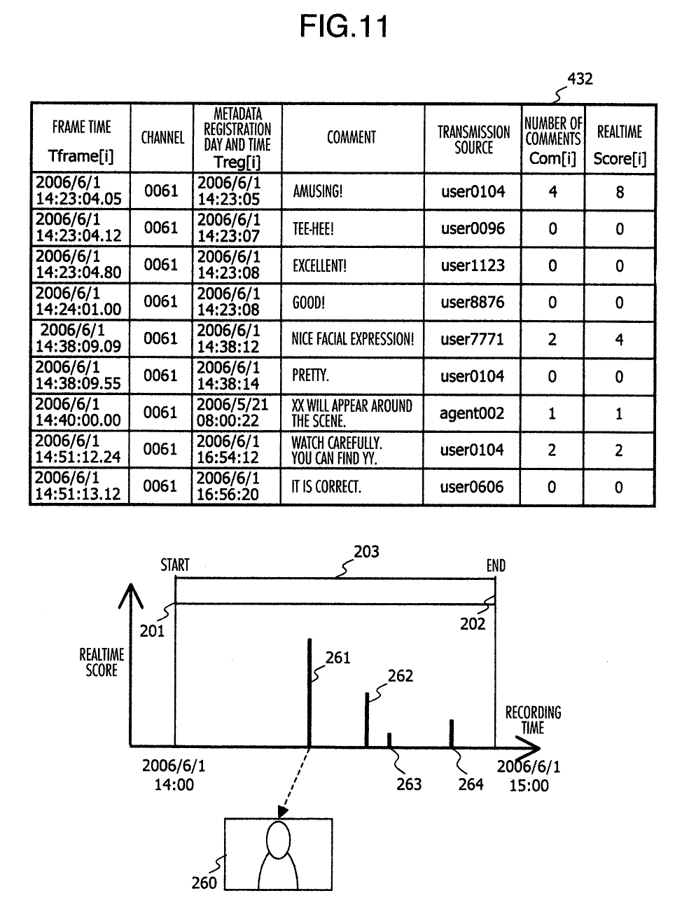

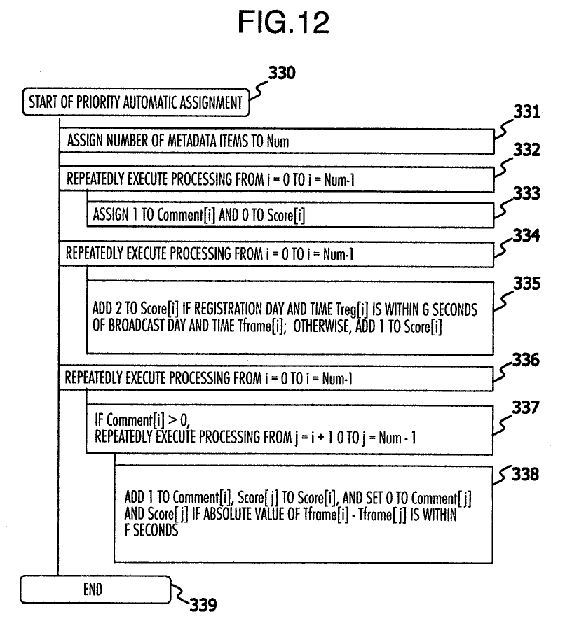

Next, by referring to FIGS. 11 and 12, description will be given of another example of the weighting operation to select a frame with the maximum priority in a particular recording section. This is an example of processing to select a program thumbnail image at reception of metadata 432 via the internet for videos recorded from the start time 201 to the end time 203. According to the processing procedure shown in FIG. 12, the plural metadata items are classified into groups each of which includes metadata items having similar frame time Tframe[i]. Thereafter, a weighting operation is conducted for the metadata items of which registration day and time Treg[i] is near the frame time, i.e., the broadcast time Tframe[i] to thereby determine Score[i]. As a result, higher priority is assigned to metadata for which a comment is received at an earlier point of time relative to the broadcast time thereof (a high-speed realtime response). It is hence possible to determine as the thumbnail image an image 260 selected from the videos of the frame 261. It is also possible to assign higher priority to metadata for which a greater number of comments are received. Therefore, a thumbnail image appropriately representing the program, for example, a frame popular among the viewers can be easily extracted.

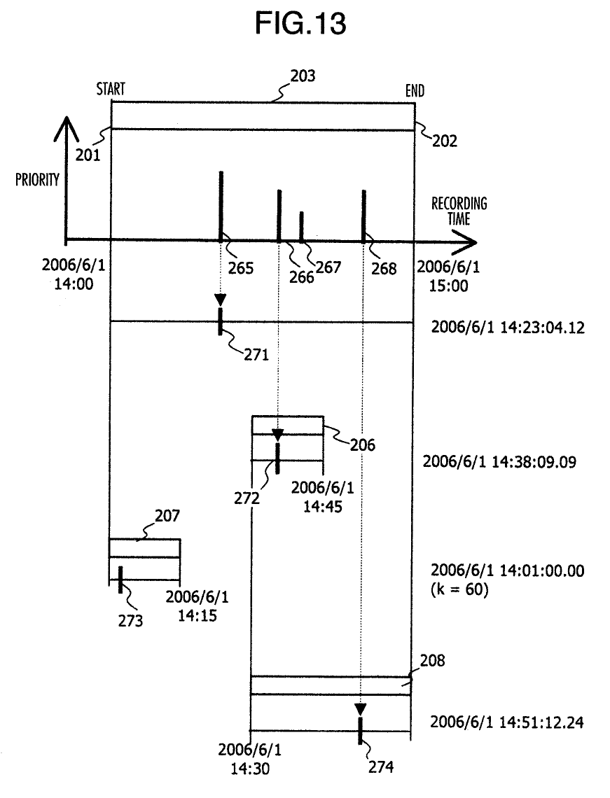

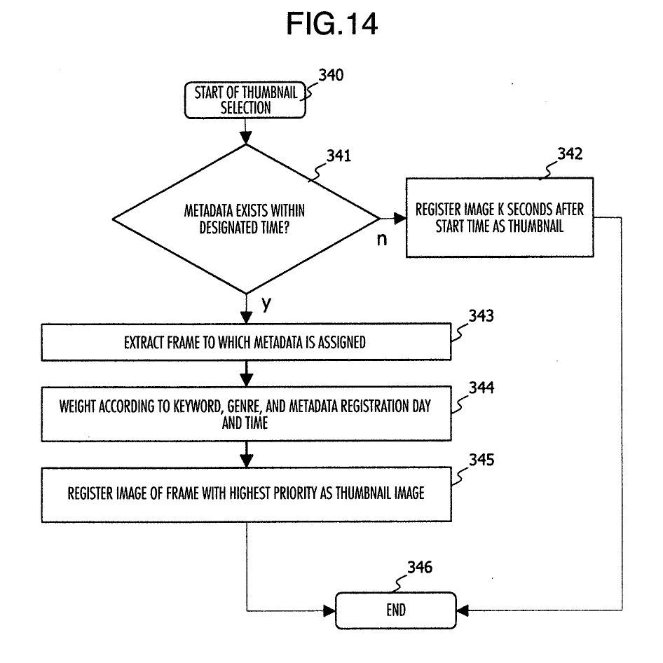

Referring to FIGS. 13 and 14, description will be given of an example of processing to select a thumbnail image in a desired recording section when metadata similar to that shown in FIG. 11 is present. If several groups of metadata items exist for videos 203 recorded from the start time 201 to the end time 202, a weighting operation is conducted according to a predetermined condition associated with a keyword, a genre, and “metadata registration day and time” (steps 343 to 344 of FIG. 14) to separate a thumbnail image, i.e., a frame with the highest priority 265 as a representative frame 271 (step 345 of FIG. 14). This similarly applies to a situation wherein metadata with the highest priority exists within an arbitrarily designated period of time 206. If no metadata exists in an arbitrarily designated period of time 207, a default method is employed to separate as a thumbnail image a frame 273 when k seconds (k=60, i.e., one minute) lapses from the start point of time (step 342 of FIG. 14). Also in a recording section 208, a target or separation frame 274 is determined through similar processing (steps 343 to 345 of FIG. 14).

The method of assigning priority and the method of selecting a separation frame shown in FIGS. 9 to 14 are examples of the weighting operation to detect a frame with the highest priority. However, the present invention is not restricted by these methods. It is possible to define various methods to select a particular frame using information defined by metadata. The frame may be selected, for example, by making a check according to presence or absence of a particular keyword, by assigning higher priority to metadata transmitted from a particular transmission source, or by preferentially selecting a frame having the earliest frame time.

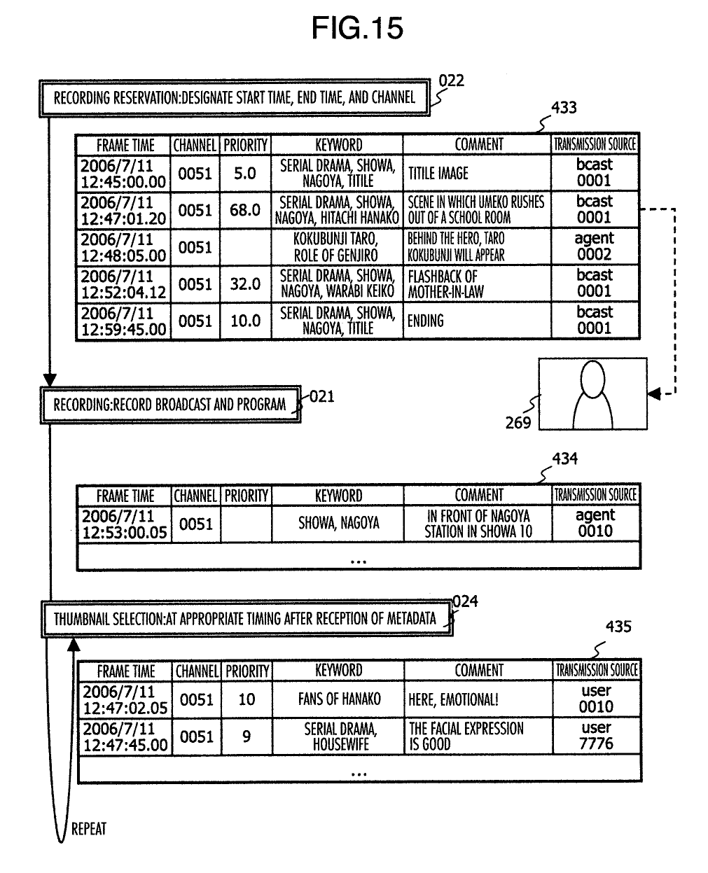

FIG. 15 shows a processing flow from the recording reservation step to the thumbnail selection step and an example of metadata to be received. At recording reservation (022), the start time, the end time, and the channel are determined. Therefore, the system receives metadata 433 having transmitted from an entity, e.g., an entity as a broadcasting station or an office to which a performer belongs. After the recording is carried out (021), the system selects, in a procedure of step 302 of FIG. 5, a thumbnail image 269 separated from a frame defined by metadata with the highest priority. After various metadata items 434 and 435 distributed from a metadata distributor, viewers, and/or various communities are received, the thumbnail selection processing 024 is executed at appropriate timing. The thumbnail selection processing is executed through, in addition to the processing of steps 305 to 307 of FIG. 5, an appropriate combination of processing, for example, by combining the priority assignment through the grouping with that through the weighting described in conjunction with FIGS. 9 to 14.

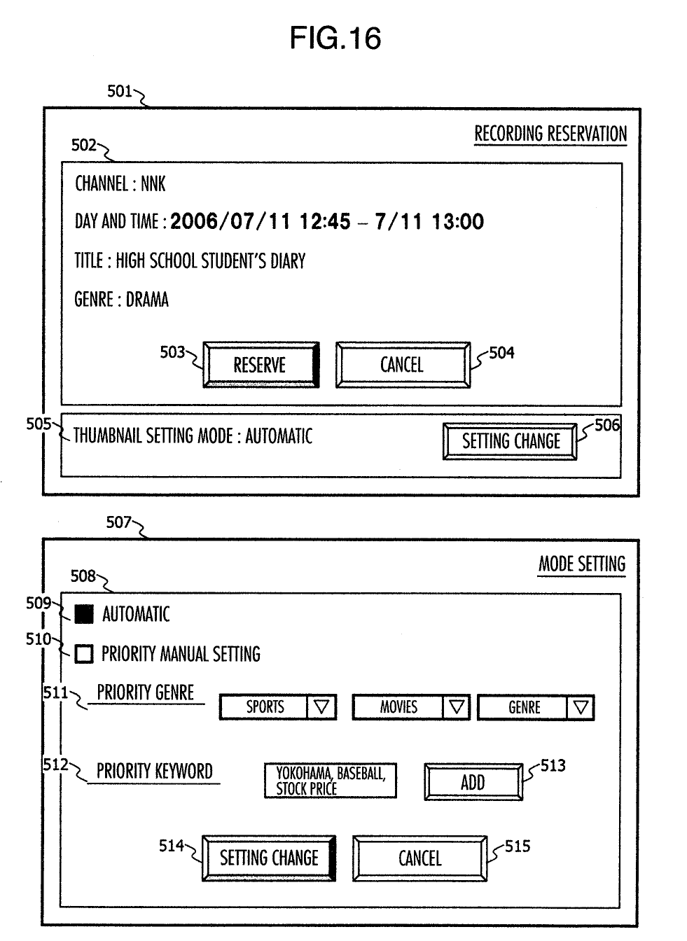

FIG. 16 shows a screen example of a video recording apparatus according to the present invention. A screen 501 is an example of a screen to conduct the recording reservation. When it is desired to reserve recording of a program, program information items such as a channel, “recording day and time”, and a title of a program to be recorded are displayed (502), and a reserve button 503 and a cancel button 504 are displayed. Also, a thumbnail image setting mode is displayed (505). If a setting change button 506 is selected, control goes to a mode setting screen 507. In the thumbnail setting mode, the user may select a “system” mode (508) in which a thumbnail image is automatically set according to priority defined by the received metadata or a mode (510) in which the user can set priority. For the priority setting condition, there may be selected, for example, “priority genre setting (511)” in which priority is increased for a program or a scene of the associated genre and “priority keyword setting (512)” in which priority is increased for metadata including a particular keyword. It may also be possible to configure the system to allow more precise setting, for example, the factor to magnify priority is set, metadata from a particular source is preferentially processed, and metadata items distributed from various communities take precedence. Alternatively, the system may be constructed in which the setting screen is not explicitly displayed, but the system automatically learns the taste of the viewer while the viewer is using the system. For example, there may be employed a system in which for a frame finally set as a thumbnail by the viewer, the system produces a score representing the reference value for the selection of the frame (e.g., the community information takes precedence or a frame selected on the basis of a keyword takes precedence in the selection). As a result, a thumbnail image having a highest score is selected in this method.

In the embodiments above, the metadata processing and the thumbnail image selection are carried out on the local recording apparatus side. However, the server may include a service in which the sequence of the above processing or part thereof is executed on the server side and the frame information to separate a thumbnail is transmitted to the recording apparatus.

According to the apparatus and the system described above, a thumbnail image which makes it possible to easily distinguish a large amount of videos recorded as above can be displayed through a simple procedure, the thumbnail image possibly reflecting the contents of the associated program or chapter. This consequently improves usability of the program retrieval and makes it possible for the viewer to easily operate the system. For the program producer and sponsor as well as other agent, this aspect of the apparatus and the system is also effectively employed to appropriately notify the viewers of the scene to be actually viewed by the viewers.

It is possible to provide the viewers with a video recorder with higher operability and with a service and a system which simplify the viewing of a large number of programs thus recorded and which facilitate management of the contents thereof.

It is possible to provide the television program producer and sponsor with a scheme to appropriately notify the viewers of the scene to be actually viewed by the viewers. Moreover, by collecting metadata items from the viewers, it is possible to inspect, for example, how the programs are viewed and to confirm the viewership.

It should be further understood by those skilled in the art that although the foregoing description has been made on embodiments of the invention, the invention is not limited thereto and various changes and modifications may be made without departing from the spirit of the invention and the scope of the appended claims.

1. A video recording apparatus, comprising:
a receiver for receiving video information from an external device;
a recorder for recording video information received by the receiver; and
a controller for separating a thumbnail image from the video information, wherein:
the video information includes first additional information including frame time information and priority information of the video information; and
the controller separates the thumbnail image from the video information on the basis of the first additional information.

2. A video recording apparatus according to claim 1, wherein the controller separates a thumbnail image corresponding to a point of time when the priority is highest within a period of time in which the video information is recorded by the recorder.

3. A video recording apparatus according to claim 1, comprising input means for selecting and separating an arbitrary thumbnail image from a plurality of thumbnail images which respectively include the priority information and which are respectively obtained at a plurality of points of time within a period of time in which the video information is recorded by the recorder.

4. A video recording apparatus according to claim 1, further comprising input means for inputting user information indicating a type of video information to which high priority is to be assigned, wherein
the controller conducts a recalculation of the priority on the basis of the user information and the first additional information and separates a thumbnail image corresponding to a point of time when the priority after the recalculation is highest.

5. A video recording apparatus according to claim 4, wherein the controller selects, if a plurality of points of time at which the priority is highest exist within a period of time in which the video information is recorded by the recorder, a point of time at which the priority is high on the basis of the user information to thereby separate a thumbnail image.

6. A video recording apparatus according to claim 1, wherein the controller makes a check to determine similarity between images at a plurality of points of time at which the first additional information is added to the video information within a period of time in which the video information is recorded by the recorder, assigns a higher weight to the priority corresponding to a point of time associated with higher similarity, and assigns a lower weight to the priority corresponding to a point of time associated with lower similarity.

7. A video recording apparatus according to claim 1, wherein:
the receiver obtains second additional information regarding the video information via an internet;
the second additional information includes frame time information of the video information, information regarding posting points of time of postings from external communities, and information regarding the number of postings from external communities; and
the controller conducts a recalculation of the priority on the basis of the first additional information and the second additional information to thereby separate the thumbnail image from the video information.

8. A video recording apparatus according to claim 7, wherein it is possible to determine, according to determination of the priority, the weights to be assigned respectively to the first additional information and the second additional information.

9. A video recording apparatus according to claim 4, wherein it is possible to determine, according to determination of the priority, the weights to be assigned respectively to the first additional information and the second additional information.

10. A video recording apparatus, comprising:
a receiver for receiving video information from an external device;
a recorder for recording video information received by the receiver; and
a controller for separating a thumbnail image from the video information, wherein:
the receiver obtains additional information regarding the video information via an internet;
the additional information includes frame time information of the video information, information regarding posting points of time of postings from external communities, and information regarding the number of postings from external communities; and
the controller calculates priority on the basis of the additional information to thereby separate the thumbnail image from the video information.

11. A video recording apparatus according to claim 10, wherein the controller separates a thumbnail image corresponding to a point of time when the priority is highest within a period of time in which the video information is recorded by the recorder.

12. A video recording apparatus according to claim 10, wherein for the calculation of the priority, the controller
1) separates the thumbnail image by preferentially processing a frame time of which the posting time is nearer to the frame time,
2) separates the thumbnail image by preferentially processing a frame time associated with a large number of postings, or
3) separates the thumbnail image, by combining the operations of 1) and 2) with each other.

13. A video recording apparatus according to claim 10, comprising input means for selecting and separating an arbitrary thumbnail image from a plurality of thumbnail images which respectively include information regarding the priority and which are respectively obtained at a plurality of points of time within a period of time in which the video information is recorded by the recorder.

14. A video recording apparatus according to claim 10, further comprising input means for inputting user information indicating a type of video information to which high priority is to be assigned, wherein the controller conducts a recalculation of the priority on the basis of the user information and the additional information and separates a thumbnail image corresponding to a point of time when the priority after the recalculation is highest.

15. A video recording apparatus according to claim 14, wherein the controller selects, if a plurality of points of time at which the priority is highest exist within a period of time in which the video information is recorded by the recorder, a point of time at which the priority is high on the basis of the user information to thereby separate a thumbnail image.

16. A video recording apparatus according to claim 10, wherein the controller makes a check to determine similarity between images at a plurality of points of time at which the additional information is added to the video information within a period of time in which the video information is recorded by the recorder, assigns a higher weight to the priority corresponding to a point of time associated with higher similarity, and assigns a lower weight to the priority corresponding to a point of time associated with lower similarity.

17. A video recording apparatus according to claim 14, wherein it is possible to determine, according to determination of the priority, the weights to be assigned respectively to the additional information and the user information.
